(19) United States
(12) Patent Application Publication
(10) Pub. No.: US 2016/0060509 A1
(43) Pub. Date: Mar. 3, 2016

(54) NON-METALLIC CROSS-LINKING AGENT FOR ULTRA-HIGH TEMPERATURE FRACTURING FLUID, AND FRACTURING FLUID, PREPARATION AND USE THEREOF

(71) Applicant: PetroChina Company Limited, Beijing (CN)

(72) Inventors: Chao WANG, Beijing (CN); Jian OUYANG, Beijing (CN); Zhuoyan ZHU, Beijing (CN); Junjie XUE, Beijing (CN); Feng WANG, Beijing (CN); Yuanyuan WANG, Beijing (CN)

(21) Appl. No.: 14/808,462

(22) Filed: Jul. 24, 2015

(30) Foreign Application Priority Data
Sep. 1, 2014 (CN) 201410441457.6

(51) Int. Cl. C09K 8/68

(52) U.S. Cl. CPC C09K 8/685

(57) ABSTRACT

The present disclosure provides a non-metallic cross-linking agent for ultra-high temperature fracturing fluids, and a fracturing fluid, the preparation and use thereof. The non-metallic cross-linking agent of the disclosure can be prepared from the following components in weight percentage: 0.1% to 0.5% of an organic aldehyde, 0.01% to 0.05% of an organic phenol, 0 to 10% of an organic alcohol, 0.05% to 0.5% of an organic acid, and the balance of water. The fracturing fluid of the disclosure can have the following advantages: low damage to the strata, low cost, good temperature resistance, and good gel-breaking performance.

### TECHNICAL FIELD

The present disclosure relates to the technical field of reservoir reconstruction in an oil and gas field, in particular, to a working fracturing fluid in superdeep-well fracturing in an oil field, and specifically to a non-metallic cross-linking agent for ultra-high temperature fracturing fluids, and a fracturing fluid, the preparation and use thereof.

### BACKGROUND

In recent years, with the deepened understanding of the geological distribution pattern of deep-seated oil and gas pools as well as the improved exploration technology, exploration of deep-seated oil and gas pools has achieved important developments, which make an increasing demand on the fracturing technology. With the advance in oil exploration technology, development of oil and gas resources has been continuously progressing in depth and breadth. The drilled well is increasingly deeper and the temperature of reservoir is increasingly higher, which require the fracturing fluid system to have higher resistance to temperature and shear, and require the fracturing fluid to keep a good rheological property and sand-carrying capability at a reservoir temperature of 180° C., or even 200° C. or more.

Current fracturing fluid systems mainly use a vegetable gum or derivatives thereof as a thickening agent, and an organometallic compound as a cross-linking agent. However, there are some problems. In one aspect, the long polymeric chain of common vegetable gum thickening agents is degraded quickly when the temperature reaches 177° C.; the cross-linked structure of fracturing fluids having a vegetable gum is hydrolyzed at low system pH, even more seriously at a high temperature; and the increasing demand for the amount of guar gum driven by the global massive exploitation of shale gas and tight gas has been pushing up the price of guar gum, from 25,000 RMB per ton in 2010 to 120,000 RMB per ton in 2012, which causes not only a substantial increase in the cost of fracturing, but also a shortage of the product, influencing the regular operation of reservoir reconstruction in oil and gas fields and the achievement of the production task. In another aspect, the conventional organoboron-crosslinked fracturing fluid is only suitable for use at a temperature of 150° C. or less, and is difficult to keep a good performance at an ultra-high temperature (180° C. or more). Although an organo-zirconium cross-linking agent can improve the temperature resistance of the fracturing fluid, the problem that a large amount of residues of organo-zirconium-crosslinked fracturing fluids would cause serious damage to the strata remains unsettled.

On the whole, although currently some fracturing fluid systems satisfy the requirement of the ultra-high temperature to some extent, they cannot meet the demands for low cost, low damage and high-temperature resistance.

### SUMMARY OF THE DISCLOSURE

One objective of the present disclosure is to provide a non-metallic cross-linking agent for ultra-high temperature fracturing fluids, which has characteristics such as gel formation under an acidic condition and low damage, etc.

Another objective of the present disclosure is to provide a method for producing the non-metallic cross-linking agent for ultra-high temperature fracturing fluids.

Still another objective of the present disclosure is to provide a fracturing fluid formulated by using the non-metallic cross-linking agent for ultra-high temperature fracturing fluids.

Another objective of the present disclosure is to provide a method for producing the fracturing fluid.

Still another objective of the present disclosure is to provide the use of the non-metallic cross-linking agent for ultra-high temperature fracturing fluids in the preparation of a fracturing fluid for oil and gas wells.

To achieve the above objects, in one aspect, the present disclosure provides a non-metallic cross-linking agent for ultra-high temperature fracturing fluids, the non-metallic cross-linking agent being prepared from the following components in weight percentage: 0.1% to 0.5% of an organic aldehyde, 0.01% to 0.05% of an organic phenol, 0 to 10% of an organic alcohol, 0.05% to 0.5% of an organic acid, and the balance of water. In some embodiments, the composition comprises: 0.5% of an organic aldehyde, 0.05% of an organic phenol, 5% of an organic alcohol, 0.5% of an organic acid, and the balance of water. The percentages are calculated on the basis that the total weight of the cross-linking agent is 100%.

In the non-metallic cross-linking agent described herein, in some embodiments, the organic aldehyde is at least one selected from paraformaldehyde, formaldehyde and hexamethylene tetramine In some example, the organic aldehyde can comprise hexamethylene tetramine

In the non-metallic cross-linking agent described herein, in some embodiments, the organic phenol is at least one selected from hydroquinone, resorcinol and phenol. In some example, the organic phenol is resorcinol.

In the non-metallic cross-linking agent a described herein, in some embodiments, the organic alcohol is at least one selected from n-butanol, isopropanol and ethyl butyl propanediol. In some example, the organic alcohol is isopropanol.

In the non-metallic cross-linking agent described herein, in some embodiments, the organic acid is at least one selected from acetic acid, formic acid, and aminosulfonic acid. In some example, the organic acid is aminosulfonic acid.

In another aspect, the present disclosure provides a method for preparing any of the non-metallic cross-linking agents for ultra-high temperature fracturing fluids as described herein, comprising: adding an organic alcohol, an organic acid and an organic aldehyde into water, stirring and mixing them uniformly and heating them to elevate the temperature; adding an organic phenol thereto; and allowing a reaction to proceed while maintaining a constant temperature, so as to produce the non-metal-ion cross-linking agent.

In the method for preparing the non-metallic cross-linking agent for ultra-high temperature fracturing fluids, after the addition of the organic alcohol, the organic acid and the organic aldehyde into water, the method can include mixing the reactants uniformly under stirring and heating the mixture to a temperature of 90° C. to 95° C.

In the method for preparing the non-metallic cross-linking agent for ultra-high temperature fracturing fluids, the method can include allowing the reaction to proceed for 3 to 4 hours while maintaining a constant temperature after the addition of the organic phenol.

In still another aspect, fracturing fluid can be formulated by using any of the non-metallic cross-linking agents described herein for ultra-high temperature fracturing fluids.

In the fracturing fluid, the non-metallic cross-linking agent can be used in an amount, in terms of weight percentage, of 0.1% to 0.25% in the fracturing fluid, wherein the weight percentage is calculated on the basis that the total weight of the fracturing fluid is 100%.

The fracturing fluid can further include the following components in weight percentage: 0.4% to 0.8% of a synthetic polymer, 0.1% to 0.2% of dodecyl ammonium chloride, 0.1% to 0.2% of a demulsifying agent SP169, 0.01% to 0.3% of ammonium persulfate, and the balance of water.

In some embodiments, the fracturing fluid can comprise the non-metallic cross-linking agent for ultra-high temperature fracturing fluids in an amount, in terms of weight percentage, of 0.25%.

In some embodiments, the fracturing fluid also comprises the following components in weight percentage: 0.4% of a synthetic polymer, 0.2% of dodecyl ammonium chloride, 0.1% of a demulsifying agent, 0.05% of ammonium persulfate, and the balance of water.

That is, the fracturing fluid comprises the following components in weight percentage: 0.4% of a synthetic polymer, 0.2% of dodecyl ammonium chloride, 0.25% of the non-metallic cross-linking agent for ultra-high temperature fracturing fluids as described herein, 0.1% of a demulsifying agent, 0.05% of ammonium persulfate, and the balance of water.

In the fracturing fluid, the demulsifying agent can be a demulsifying agent commonly used in the art, and any commercially available conventional demulsifying agent can be used. In some examples, the demulsifying agent include the demulsifying agent SP169.

In the fracturing fluid, the synthetic polymer can be synthesized from acrylamide and 2-acrylamide-2-methylpropanesulfonic acid, and has a molecular weight between 6,000,000 to 7,000,000.

The synthetic reaction between acrylamide and 2-acrylamide-2-methyl-propanesulfonic acid may be a conventional reaction. For example, the reaction can be carried out at a polymerization temperature of 10° C. to 25° C. for 3 to 5 hours.

In some embodiments, the ratio by mass of acrylamide to 2-acrylamide-2-methylpropanesulfonic acid can be 1:1 to 3:1, for example 2:1.

The dodecyl ammonium chloride in the ultra-high temperature fracturing fluid is used as a clay stabilizing agent for preventing clay from swelling or migration due to hydration in a water-sensitive stratum.

The demulsifying agent SP169 in the ultra-high temperature fracturing fluid is adsorbed to the oil-water interface, thus forming an interfacial film with low strength and facilitating demulsification.

The ammonium persulfate in the ultra-high temperature fracturing fluid is used as a gel-breaking agent for the gel-breaking of the fracturing fluid, ensuring the complete flowback of the residual fracturing fluid after the operation is done.

In still another aspect, methods for preparing the fracturing fluid are provided. The method can comprise: adding a synthetic polymer in water and then forming a uniform aqueous solution of the polymer under stirring. The method can comprise sequentially adding dodecyl ammonium chloride, a demulsifying agent and ammonium persulfate to the uniform aqueous solution of the polymer, and mixing them uniformly. The method can further comprise adding a cross-linking agent, and forming a hangable jelly-like fracturing fluid after stirring.

In the method for producing the fracturing fluid, in some embodiments, the stirring after the addition of a synthetic polymer to water can be carried out at 400 r/min, so as to form a uniform aqueous solution of the polymer.

In the method for producing the fracturing fluid, in some embodiments, after the addition of a synthetic polymer to water, the stirring can be carried out for 0.5 to 1 hour, for example 2 hours.

In the method for producing the fracturing fluid, in some embodiments, after the addition of the cross-linking agent, the stirring can be carried out for 2 to 5 min to form a hangable jelly-like fracturing fluid.

In still another aspect, the non-metallic cross-linking agents for ultra-high temperature fracturing fluids in the preparation of a fracturing fluid can be used in oil and gas wells.

In some examples, the fracturing fluid can be operated at a temperature below 200° C., for example at 190° C. to 200° C.

Described herein are non-metallic cross-linking agent for ultra-high temperature fracturing fluids, and a fracturing fluid, the preparation and use thereof The fracturing fluid prepared with the non-metallic cross-linking agent for ultra-high temperature fracturing fluids can have the following advantages:

(1) low damage to the strata: the defect of heavy damage caused by a fracturing fluid crosslinked by inorganic metal or organic metal compounds can be avoided by using a non-metal-ion cross-linking agent to cross-link the thickening agent under an acidic condition;

(2) low cost: the polymeric thickening agent has advantages such as gel formation under an acidic condition, a low addition amount, easy availability and low cost, as compared to vegetable gum-type thickening agents;

(3) good temperature resistance: the fracturing fluid prepared by cross-linking of the cross-linking agent and the synthetic polymer as described herein has excellent temperature resistance and shear resistance under a condition of 190° C.; and

(4) good gel-breakinggel-breaking performance: use of a capsule-type gel-breakinggel-breaking technique can ensure complete gel-breakinggel-breaking and flowback of the fracturing fluid after the fracture operation is done, thus reducing the damage to the strata.

### BRIEF DESCRIPTION OF THE DRAWINGS

FIG. 1 is a curve graph illustrating the temperature resistance and shear resistance of the fracturing fluid under a condition of 190° C. and 170 s⁻¹.

### DETAILED DESCRIPTION OF THE DISCLOSURE

Hereinafter, the process for implementing the compositions and methods described herein and the beneficial effects brought about by the compositions and methods are set out in detail with specific examples, which are intended to help readers have a better understanding of the spirit and features of the compositions and methods, but do not limit the implementable scope of this application.

### Example 1

An ultra-high temperature fracturing fluid as described herein was formulated by using 0.4% of a synthetic polymer (which was prepared by reacting acrylamide and 2-acrylamide-2-methylpropanesulfonic acid in a mass ratio of 2:1 at 12° C. for 4 hours, and had a viscosity average molecular weight of 6,530,000), 0.25% of a cross-linking agent, 0.2% of dodecyl ammonium chloride, 0.1% of a demulsifying agent SP169, 0.05% of ammonium persulfate, and the balance of water. The preparation process was as follows: adding 0.4% of the synthetic polymer as a thickening agent into water, followed by stirring for 1.5 hours at 400 r/min to form a uniform aqueous solution of the polymer; to the uniform aqueous solution of the polymer, sequentially adding 0.2% of dodecyl ammonium chloride, 0.1% of a demulsifying agent, and 0.05% of ammonium persulfate, and mixing them uniformly before adding 0.25% of a cross-linking agent; stirring the system for 2.5 min to form a hangable jelly-like fracturing fluid.

Herein the cross-linking agent had a composition of: 0.5% of hexamethylene tetramine as an organic aldehyde, 0.05% of resorcinol as an organic phenol, 5% of isopropanol as an organic alcohol, 0.5% of aminosulfonic acid as an organic acid, and the balance of water. The cross-linking agent was prepared via the following steps:

adding an organic alcohol, an organic acid and an organic aldehyde into water, stirring and mixing them uniformly, and heating them to elevate the temperature to 90° C.; then adding an organic phenol, and allowing the reaction to proceed for 3 hours while maintaining a constant temperature, so as to produce the above non-metal-ion cross-linking agent.

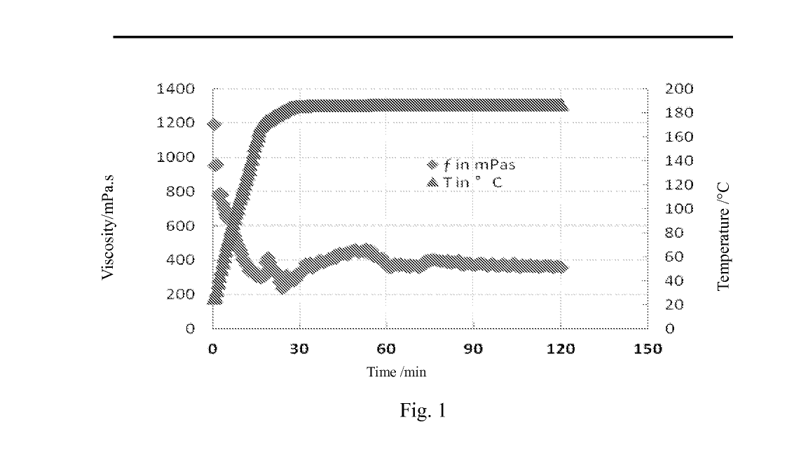

The fracturing fluid was evaluated for its performance. The measurement was conducted according to the oil-and-natural gas industrial standard SY/T 5107-2005, namely “Method for evaluating the performance of a water-based fracturing fluid”, and the results are shown in Table 1. The rheological property of the fracturing fluid is shown in FIG. 1.

TABLE 1
Results of evaluation of the performance of the
fracturing fluid as described herein (190° C.)

| | | | | | Viscosity of | |
|---|---|---|---|---|---|---|
| Shear | Shear viscosity (mPa · s) | | | | gel-breaking | Content of |
| Temp. | | 60.0 | 90.0 | 120.0 | fluid | residues |
| (° C.) | initial | min | min | min | (mPa · s) | (mg/L) |
| 190 | 1193.0 | 235.8 | 370.7 | 358.8 | 1.37 | 27 |

As seen from the evaluation results in Table 1 and FIG. 1, when the shear temperature was 190° C., the shear viscosity at 120 min was 358.8 mPa·s, the viscosity after gel breaking was 1.37 mPa·s and the gel-breaking fluid was clear and transparent, and the content of residues was 27 mg/L. It can be seen that the ultra-high temperature fracturing fluid showed characteristics such as good high-temperature resistance and shear resistance, complete gel breaking, and a low content of residues, and can satisfy the requirements of on-site operations.

### Example 2

An ultra-high temperature fracturing fluid as described herein was formulated by using 0.8% of a synthetic polymer (which was prepared by reacting acrylamide and 2-acrylamide-2-methylpropanesulfonic acid in a mass ratio of 1:1 at 12° C. for 4 hours, and had a viscosity average molecular weight of 6,750,000), 0.25% of a cross-linking agent, 0.2% of dodecyl ammonium chloride, 0.1% of a demulsifying agent SP169, 0.05% of ammonium persulfate and the balance of water. The preparation process was as follows: adding 0.8% of the synthetic polymer as a thickening agent into water, followed by stirring for 1 hour at 400 r/min to form a uniform aqueous solution of the polymer; to the uniform aqueous solution of the polymer, sequentially adding 0.2% of dodecyl ammonium chloride, 0.1% of a demulsifying agent, and 0.05% of ammonium persulfate, and mixing them uniformly before adding 0.25% of a cross-linking agent; stirring the system for 3.5 min to form a hangable jelly-like fracturing fluid.

Herein the cross-linking agent had a composition of: 0.5% of formaldehyde as an organic aldehyde, 0.05% of resorcinol, 5% of n-butanol, 0.5% of acetic acid, and the balance of water. The cross-linking agent was prepared via the following steps:

adding an organic alcohol, an organic acid and an organic aldehyde into water, stirring and mixing them uniformly, and heating them to elevate the temperature to 95° C.; then adding an organic phenol, and allowing the reaction to proceed for 4 hours while maintaining a constant temperature, so as to produce the above non-metal-ion cross-linking agent.

The fracturing fluid was evaluated for its performance. The measurement was conducted according to the oil-and-natural gas industrial standard SY/T 5107-2005, namely “Method for evaluating the performance of a water-based fracturing fluid”, and the results are shown in Table 2.

TABLE 2
Results of evaluation of the performance of the
fracturing fluid as described herein (190° C.)

| | | | | | Viscosity of | |
|---|---|---|---|---|---|---|
| Shear | Shear viscosity (mPa · s) | | | | gel-breaking | Content of |
| Temp. | | 60.0 | 90.0 | 120.0 | fluid | residues |
| (° C.) | initial | min | min | min | (mPa · s) | (mg/L) |
| 190 | 1698.3 | 215.3 | 256.2 | 198.6 | 2.02 | 16 |

Table 2 shows that the ultra-high temperature fracturing fluid prepared in Example 2 showed characteristics such as good high-temperature resistance and shear resistance, complete gel breaking, and a low content of residues, and can satisfy the requirements of on-site operations.

### Example 3

An ultra-high temperature fracturing fluid as described herein was formulated by using 0.8% of a synthetic polymer (which was prepared by reacting acrylamide and 2-acrylamide-2-methylpropanesulfonic acid in a mass ratio of 1.8:1 at 12° C. for 4 hours, and had a viscosity average molecular weight of 6,150,000), 0.25% of a cross-linking agent, 0.2% of dodecyl ammonium chloride, 0.1% of a demulsifying agent SP169, 0.3% of ammonium persulfate, and the balance of water. The preparation process was as follows: adding 0.8% of the synthetic polymer as a thickening agent into water, followed by stirring for 1.5 hours at 400 r/min to form a uniform aqueous solution of the polymer; to the uniform aqueous solution of the polymer, sequentially adding 0.2% of dodecyl ammonium chloride, 0.1% of a demulsifying agent, and 0.3% of ammonium persulfate, and mixing them uniformly before adding 0.25% of a cross-linking agent; stirring the system for 4 min to form a hangable jelly-like fracturing fluid.

Herein the cross-linking agent had a composition of: 0.5% of paraformaldehyde, 0.05% of resorcinol, 5% of isopropanol, 0.5% of formic acid, and the balance of water; and the cross-linking agent was prepared via the following steps:

adding an organic alcohol, an organic acid and an organic aldehyde into water, stirring and mixing them uniformly, and heating them to elevate the temperature to 94° C.; then adding an organic phenol, and allowing the reaction to proceed for 3.5 hours while maintaining a constant temperature, so as to produce the above non-metal-ion cross-linking agent.

The fracturing fluid was evaluated for its performance. The measurement was conducted according to the oil-and-natural gas industrial standard SY/T 5107-2005, namely “Method for evaluating the performance of a water-based fracturing fluid”, and the results are shown in Table 3.

TABLE 3
Results of evaluation of the performance of the
fracturing fluid as described herein (190° C.)

| | | | | | Viscosity of | |
|---|---|---|---|---|---|---|
| Shear | Shear viscosity (mPa · s) | | | | gel-breaking | Content of |
| Temp. | | 60.0 | 90.0 | 120.0 | fluid | residues |
| (° C.) | initial | min | min | min | (mPa · s) | (mg/L) |
| 190 | 1215.3 | 156.2 | 242.2 | 213.6 | 1.63 | 19 |

Table 3 shows that the ultra-high temperature fracturing fluid prepared in Example 3 showed characteristics such as good high-temperature resistance and shear resistance, complete gel breaking, and a low content of residues, and can satisfy the requirements of on-site operations.

### Example 4

An ultra-high temperature fracturing fluid as described herein was formulated by using 0.8% of a synthetic polymer (which was prepared by reacting acrylamide and 2-acrylamide-2-methylpropanesulfonic acid in a mass ratio of 2.2:1 at 12° C. for 4 hours, and had a viscosity average molecular weight of 6,840,000), 0.25% of a cross-linking agent, 0.2% of dodecyl ammonium chloride, 0.1% of a demulsifying agent SP169, 0.1% of ammonium persulfate, and the balance of water. The preparation process was as follows: adding 0.8% of the synthetic polymer as a thickening agent into water, followed by stirring for 1.2 hours at 400 r/min to form a uniform aqueous solution of the polymer; to the uniform aqueous solution of the polymer, sequentially adding 0.2% of dodecyl ammonium chloride, 0.1% of a demulsifying agent and 0.1% of ammonium persulfate, and mixing them uniformly before adding 0.25% of a cross-linking agent; stirring the system for 5 min to form a hangable jelly-like fracturing fluid.

Herein the cross-linking agent had a composition of: 0.5% of hexamethylene tetramine, 0.05% of phenol, 5% of ethyl butyl propanediol, 0.5% of acetic acid, and the balance of water; and the cross-linking agent was prepared via the following steps:

adding an organic alcohol, an organic acid and an organic aldehyde into water, stirring and mixing them uniformly, and heating them to elevate the temperature to 93° C.; then adding an organic phenol, and allowing the reaction to proceed for 3.5 hours while maintaining a constant temperature, so as to produce the above non-metal-ion cross-linking agent.

The fracturing fluid was evaluated for its performance. The measurement was conducted according to the oil-and-natural gas industrial standard SY/T 5107-2005, namely “Method for evaluating the performance of a water-based fracturing fluid”, and the results are shown in Table 4.

TABLE 4
Results of evaluation of the performance of the
fracturing fluid as described herein (190° C.)

| | | | | | Viscosity of | |
|---|---|---|---|---|---|---|
| Shear | Shear viscosity (mPa · s) | | | | gel-breaking | Content of |
| Temp. | | 60.0 | 90.0 | 120.0 | fluid | residues |
| (° C.) | initial | min | min | min | (mPa · s) | (mg/L) |
| 190 | 1253.6 | 216.3 | 29836 | 246.5 | 1.23 | 21 |

Table 4 shows that the ultra-high temperature fracturing fluid prepared in Example 4 showed characteristics such as good high-temperature resistance and shear resistance, complete gel breaking, and a low content of residues, and can satisfy the requirements of on-site operations.

### Example 5

An ultra-high temperature fracturing fluid as described herein was formulated by using 0.6% of a synthetic polymer (which was prepared by reacting acrylamide and 2-acrylamide-2-methylpropanesulfonic acid in a mass ratio of 3:1 at 12° C. for 4 hours, and had a viscosity average molecular weight of 6,210,000), 0.25% of a cross-linking agent, 0.2% of dodecyl ammonium chloride, 0.1% of a demulsifying agent SP169, 0.05% of ammonium persulfate, and the balance of water. The preparation process was as follows: adding 0.6% of the synthetic polymer as a thickening agent into water, followed by stirring for 1.5 hours at 400 r/min to form a uniform aqueous solution of the polymer; to the uniform aqueous solution of the polymer, sequentially adding 0.2% of dodecyl ammonium chloride, 0.1% of a demulsifying agent and 0.05% of ammonium persulfate, and mixing them uniformly before adding 0.25% of a cross-linking agent; stirring the system for 3 min to form a hangable jelly-like fracturing fluid.

Herein the cross-linking agent had a composition of: 0.5% of formaldehyde, 0.05% of resorcinol, 5% of ethyl butyl propanediol, 0.5% of formic acid, and the balance of water; and the cross-linking agent was prepared via the following steps:

adding an organic alcohol, an organic acid and an organic aldehyde into water, stirring and mixing them uniformly, and heating them to elevate the temperature to 92° C.; then adding an organic phenol, and allowing the reaction to proceed for 3.5 hours while maintaining a constant temperature, so as to produce the above non-metal-ion cross-linking agent.

The fracturing fluid was evaluated for its performance. The measurement was conducted according to the oil-and-natural gas industrial standard SY/T 5107-2005, namely “Method for evaluating the performance of a water-based fracturing fluid”, and the results are shown in Table 5.

TABLE 5
Results of evaluation of the performance of the
fracturing fluid as described herein (190° C.)

| | | | | | Viscosity of | |
|---|---|---|---|---|---|---|
| Shear | Shear viscosity (mPa · s) | | | | gel-breaking | Content of |
| Temp. | | 60.0 | 90.0 | 120.0 | fluid | residues |
| (° C.) | initial | min | min | min | (mPa · s) | (mg/L) |
| 190 | 1863.2 | 256.3 | 302.2 | 254.3 | 1.98 | 25 |

Table 5 shows that the ultra-high temperature fracturing fluid prepared in Example 5 showed characteristics such as good high-temperature resistance and shear resistance, complete gel breaking, and a low content of residues, and can satisfy the requirements of on-site operations.

### Example 6

An ultra-high temperature fracturing fluid as described herein was formulated by using 0.6% of a synthetic polymer (which was prepared by reacting acrylamide and 2-acrylamide-2-methylpropanesulfonic acid in a mass ratio of 1.5:1 at 12° C. for 4 hours, and had a viscosity average molecular weight of 6,420,000), 0.25% of a cross-linking agent, 0.1% of dodecyl ammonium chloride, 0.1% of a demulsifying agent SP169, 0.05% of ammonium persulfate, and the balance of water. The preparation process was as follows: adding 0.6% of the synthetic polymer as a thickening agent into water, followed by stirring for 0.5 hour at 400 r/min to form a uniform aqueous solution of the polymer; to the uniform aqueous solution of the polymer, sequentially adding 0.1% of dodecyl ammonium chloride, 0.1% of a demulsifying agent and 0.05% of ammonium persulfate, and mixing them uniformly before adding 0.25% of a cross-linking agent; stirring the system for 3 min to form a hangable jelly-like fracturing fluid.

Herein the cross-linking agent had a composition of: 0.5% of paraformaldehyde, 0.05% of phenol, 5% of ethyl butyl propanediol, 0.5% of aminosulfonic acid, and the balance of water; and the cross-linking agent was prepared via the following steps:

adding an organic alcohol, an organic acid and an organic aldehyde into water, stirring and mixing them uniformly, and heating them to elevate the temperature to 93° C.; then adding an organic phenol, and allowing the reaction to proceed for 3.5 hours while maintaining a constant temperature, so as to produce the above non-metal-ion cross-linking agent.

The fracturing fluid was evaluated for its performance. The measurement was conducted according to the oil-and-natural gas industrial standard SY/T 5107-2005, namely “Method for evaluating the performance of a water-based fracturing fluid”, and the results are shown in Table 6.

TABLE 6
Results of evaluation of the performance of the
fracturing fluid as described herein (190° C.)

| | | | | | Viscosity of | |
|---|---|---|---|---|---|---|
| Shear | Shear viscosity (mPa · s) | | | | gel-breaking | Content of |
| Temp. | | 60.0 | 90.0 | 120.0 | fluid | residues |
| (° C.) | initial | min | min | min | (mPa · s) | (mg/L) |
| 190 | 1236.5 | 195.3 | 256.3 | 198.5 | 2.30 | 21 |

Table 6 shows that the ultra-high temperature fracturing fluid prepared in Example 6 showed characteristics such as good high-temperature resistance and shear resistance, complete gel breaking, and a low content of residues, and can satisfy the requirements of on-site operations.

### Example 7

An ultra-high temperature fracturing fluid as described herein was formulated by using 0.6% of a synthetic polymer (which was prepared by reacting acrylamide and 2-acrylamide-2-methylpropanesulfonic acid in a mass ratio of 7:3 at 12° C. for 4 hours, and had a viscosity average molecular weight of 6,270,000), 0.25% of a cross-linking agent, 0.2% of dodecyl ammonium chloride, 0.2% of a demulsifying agent SP169, 0.05% of ammonium persulfate, and the balance of water. The preparation process was as follows: adding 0.4% of the synthetic polymer as a thickening agent into water, followed by stirring for 1 hour at 400 r/min to form a uniform aqueous solution of the polymer; to the uniform aqueous solution of the polymer, sequentially adding 0.2% of dodecyl ammonium chloride, 0.2% of a demulsifying agent and 0.05% of ammonium persulfate, and mixing them uniformly before adding 0.25% of a cross-linking agent; stirring the system for 3.5 min to form a hangable jelly-like fracturing fluid.

Herein the cross-linking agent had a composition of: 0.5% of formaldehyde, 0.05% of hydroquinone, 5% of isopropanol, 0.5% of aminosulfonic acid, and the balance of water; and the cross-linking agent was prepared via the following steps:

adding an organic alcohol, an organic acid and an organic aldehyde into water, stirring and mixing them uniformly, and heating them to elevate the temperature to 94° C.; then adding an organic phenol, and allowing the reaction to proceed for 3 hours while maintaining a constant temperature, so as to produce the above non-metal-ion cross-linking agent.

The fracturing fluid was evaluated for its performance. The measurement was conducted according to the oil-and-natural gas industrial standard SY/T 5107-2005, namely “Method for evaluating the performance of a water-based fracturing fluid”, and the results are shown in Table 7.

TABLE 7
Results of evaluation of the performance of the
fracturing fluid as described herein (190° C.)

| | | | | | Viscosity of | |
|---|---|---|---|---|---|---|
| Shear | Shear viscosity (mPa · s) | | | | gel-breaking | Content of |
| Temp. | | 60.0 | 90.0 | 120.0 | fluid | residues |
| (° C.) | initial | min | min | min | (mPa · s) | (mg/L) |
| 190 | 1025.6 | 213.5 | 245.3 | 198.2 | 1.95 | 21 |

Table 7 shows that the ultra-high temperature fracturing fluid prepared in Example 7 showed characteristics such as good high-temperature resistance and shear resistance, complete gel breaking, and a low content of residues, and can satisfy the requirements of on-site operations.

### Example 8

An ultra-high temperature fracturing fluid as described herein was formulated by using 0.8% of a synthetic polymer (which was prepared by reacting acrylamide and 2-acrylamide-2-methylpropanesulfonic acid in a mass ratio of 1:1 at 12° C. for 4 hours, and had a viscosity average molecular weight of 6,750,000), 0.25% of a cross-linking agent, 0.2% of dodecyl ammonium chloride, 0.1% of a demulsifying agent SP169, 0.09% of ammonium persulfate, and the balance of water. The preparation process was as follows: adding 0.8% of the synthetic polymer as a thickening agent into water, followed by stirring for 1 hour at 400 r/min to form a uniform aqueous solution of the polymer; to the uniform aqueous solution of the polymer, sequentially adding 0.2% of dodecyl ammonium chloride, 0.1% of a demulsifying agent and 0.05% of ammonium persulfate, and mixing them uniformly before adding 0.25% of a cross-linking agent; stirring the system for 4.5 min to form a hangable jelly-like fracturing fluid.

Herein the cross-linking agent had a composition of: 0.1% of formaldehyde, 0.05% of resorcinol, 5% of n-butanol, 0.5% of aminosulfonic acid, and the balance of water; and the cross-linking agent was prepared via the following steps:

adding an organic alcohol, an organic acid and an organic aldehyde into water, stirring and mixing them uniformly, and heating them to elevate the temperature to 92.5° C.; then adding an organic phenol, and allowing the reaction to proceed for 3.5 hours while maintaining a constant temperature, so as to produce the above non-metal-ion cross-linking agent.

The fracturing fluid was evaluated for its performance. The measurement was conducted according to the oil-and-natural gas industrial standard SY/T 5107-2005, namely “Method for evaluating the performance of a water-based fracturing fluid”, and the results are shown in Table 8.

TABLE 8
Results of evaluation of the performance of the
fracturing fluid as described herein (190° C.)

| | | | | | Viscosity of | |
|---|---|---|---|---|---|---|
| Shear | Shear viscosity (mPa · s) | | | | gel-breaking | Content of |
| Temp. | | 60.0 | 90.0 | 120.0 | fluid | residues |
| (° C.) | initial | min | min | min | (mPa · s) | (mg/L) |
| 190 | 1125.6 | 156.3 | 198.2 | 175.6 | 2.02 | 24 |

Table 8 shows that the ultra-high temperature fracturing fluid prepared in Example 8 showed characteristics such as good high-temperature resistance and shear resistance, complete gel breaking, and a low content of residues, and can satisfy the requirements of on-site operations.

### Example 9

An ultra-high temperature fracturing fluid as described herein was formulated by using 0.8% of a synthetic polymer (which was prepared by reacting acrylamide and 2-acrylamide-2-methylpropanesulfonic acid in a mass ratio of 2.5:1 at 12° C. for 4 hours, and had a viscosity average molecular weight of 6,820,000), 0.25% of a cross-linking agent, 0.2% of dodecyl ammonium chloride, 0.1% of a demulsifying agent SP169, 0.2% of ammonium persulfate, and the balance of water. The preparation process was as follows: adding 0.8% of the synthetic polymer as a thickening agent into water, followed by stirring for 2 hours at 400 r/min to form a uniform aqueous solution of the polymer; to the uniform aqueous solution of the polymer, sequentially adding 0.2% of dodecyl ammonium chloride, 0.1% of a demulsifying agent and 0.05% of ammonium persulfate, and mixing them uniformly before adding 0.25% of a cross-linking agent; stirring the system for 4.5 min to form a hangable jelly-like fracturing fluid.

Herein the cross-linking agent had a composition of: 0.3% of paraformaldehyde, 0.02% of hydroquinone, 10% of n-butanol, 0.05% of acetic acid, and the balance of water; and the cross-linking agent was prepared via the following steps:

adding an organic alcohol, an organic acid and an organic aldehyde into water, stirring and mixing them uniformly, and heating them to elevate the temperature to 93° C.; then adding an organic phenol, and allowing the reaction to proceed for 3.5 hours while maintaining a constant temperature, so as to produce the above non-metal-ion cross-linking agent.

The fracturing fluid was evaluated for its performance. The measurement was conducted according to the oil-and-natural gas industrial standard SY/T 5107-2005, namely “Method for evaluating the performance of a water-based fracturing fluid”, and the results are shown in Table 9.

TABLE 9
Results of evaluation of the performance of the
fracturing fluid as described herein (190° C.)

| | | | | | Viscosity of | |
|---|---|---|---|---|---|---|
| Shear | Shear viscosity (mPa · s) | | | | gel-breaking | Content of |
| Temp. | | 60.0 | 90.0 | 120.0 | fluid | residues |
| (° C.) | initial | min | min | min | (mPa · s) | (mg/L) |
| 190 | 1352.7 | 251.3 | 308.9 | 215.8 | 2.03 | 19 |

Table 9 shows that the ultra-high temperature fracturing fluid prepared in Example 9 showed characteristics such as good high-temperature resistance and shear resistance, complete gel breaking, and a low content of residues, and can satisfy the requirements of on-site operations.

### Example 10

An ultra-high temperature fracturing fluid as described herein was formulated by using 0.8% of a synthetic polymer (which was prepared by reacting acrylamide and 2-acrylamide-2-methylpropanesulfonic acid in a mass ratio of 1.7:1 at 12° C. for 4 hours, and had a viscosity average molecular weight of 6,450,000), 0.25% of a cross-linking agent, 0.2% of dodecyl ammonium chloride, 0.1% of a demulsifying agent SP169, 0.25% of ammonium persulfate, and the balance of water. The preparation process was as follows: adding 0.8% of the synthetic polymer as a thickening agent into water, followed by stirring for 1.5 hours at 400 r/min to form a uniform aqueous solution of the polymer; to the uniform aqueous solution of the polymer, sequentially adding 0.2% of dodecyl ammonium chloride, 0.1% of a demulsifying agent and 0.05% of ammonium persulfate, and mixing them uniformly before adding 0.25% of a cross-linking agent; stirring the system for 4.5 min to form a hangable jelly-like fracturing fluid.

Herein the cross-linking agent had a composition of: 0.1% of hexamethylene tetramine, 0.025% of phenol, 0.25% of acetic acid, and the balance of water; and the cross-linking agent was prepared via the following steps:

adding an organic acid and an organic aldehyde into water, stirring and mixing them uniformly, and heating to elevate the temperature to 94° C.; then adding an organic phenol, and allowing the reaction to proceed for 3 hours while maintaining a constant temperature, so as to produce the above non-metal-ion cross-linking agent.

The fracturing fluid was evaluated for its performance. The measurement was conducted according to the oil-and-natural gas industrial standard SY/T 5107-2005, namely “Method for evaluating the performance of a water-based fracturing fluid”, and the results are shown in Table 10.

TABLE 10
Results of evaluation of the performance of the
fracturing fluid as described herein (190° C.)

| | | | | | Viscosity of | |
|---|---|---|---|---|---|---|
| Shear | Shear viscosity (mPa · s) | | | | gel-breaking | Content of |
| Temp. | | 60.0 | 90.0 | 120.0 | fluid | residues |
| (° C.) | initial | min | min | min | (mPa · s) | (mg/L) |
| 190 | 1122.3 | 216.5 | 279.5 | 243.6 | 2.15 | 22 |

Table 10 shows that the ultra-high temperature fracturing fluid prepared in Example 10 showed characteristics such as good high-temperature resistance and shear resistance, complete gel breaking, and a low content of residues, and can satisfy the requirements of on-site operations.

### Example 11

An ultra-high temperature fracturing fluid as described herein was formulated by using 0.8% of a synthetic polymer (which was prepared by reacting acrylamide and 2-acrylamide-2-methylpropanesulfonic acid in a mass ratio of 2.5:1 at 12° C. for 4 hours, and had a viscosity average molecular weight of 6,950,000), 0.25% of a cross-linking agent, 0.2% of dodecyl ammonium chloride, 0.1% of a demulsifying agent SP169, 0.15% of ammonium persulfate, and the balance of water. The preparation process was as follows: adding 0.8% of the synthetic polymer as a thickening agent into water, followed by stirring for 1.5 hours at 400 r/min to form a uniform aqueous solution of the polymer; to the uniform aqueous solution of the polymer, sequentially adding 0.2% of dodecyl ammonium chloride, 0.1% of a demulsifying agent and 0.05% of ammonium persulfate, and mixing them uniformly before adding 0.25% of a cross-linking agent; stirring the system for 5 min to form a hangable jelly-like fracturing fluid.

Herein the cross-linking agent had a composition of: 0.2% of paraformaldehyde, 0.03% of resorcinol, 8% of isopropanol, 0.25% of aminosulfonic acid, and the balance of water; and the cross-linking agent was prepared via the following steps:

adding an organic alcohol, an organic acid and an organic aldehyde into water, stirring and mixing them uniformly, and heating them to elevate the temperature to 94° C.; then adding an organic phenol, and allowing the reaction to proceed for 3.5 hours while maintaining a constant temperature, so as to produce the above non-metal-ion cross-linking agent.

The fracturing fluid was evaluated for its performance. The measurement was conducted according to the oil-and-natural gas industrial standard SY/T 5107-2005, namely “Method for evaluating the performance of a water-based fracturing fluid”, and the results are shown in Table 11.

TABLE 11
Results of evaluation of the performance of the
fracturing fluid as described herein (190° C.)

| | | | | | Viscosity of | |
|---|---|---|---|---|---|---|
| Shear | Shear viscosity (mPa · s) | | | | gel-breaking | Content of |
| Temp. | | 60.0 | 90.0 | 120.0 | fluid | residues |
| (° C.) | initial | min | min | min | (mPa · s) | (mg/L) |
| 190 | 1125.3 | 189.6 | 212.3 | 200.3 | 2.02 | 18 |

Table 11 shows that the ultra-high temperature fracturing fluid prepared in Example 11 showed characteristics such as good high-temperature resistance and shear resistance, complete gel breaking, and a low content of residues, and can satisfy the requirements of on-site operations.

### Example 12

An ultra-high temperature fracturing fluid as described herein was formulated by using 0.8% of a synthetic polymer (which was prepared by reacting acrylamide and 2-acrylamide-2-methylpropanesulfonic acid in a mass ratio of 1.7:1 at 12° C. for 4 hours, and had a viscosity average molecular weight of 6,450,000), 0.1% of a cross-linking agent, 0.2% of dodecyl ammonium chloride, 0.1% of a demulsifying agent SP169, 0.25% of ammonium persulfate, and the balance of water. The preparation process was as follows: adding 0.8% of the synthetic polymer as a thickening agent into water, followed by stirring for 1.5 hours at 400 r/min to form a uniform aqueous solution of the polymer; to the uniform aqueous solution of the polymer, sequentially adding 0.2% of dodecyl ammonium chloride, 0.1% of a demulsifying agent and 0.05% of ammonium persulfate, and mixing them uniformly before adding 0.25% of a cross-linking agent; stirring the system for 4.5 min to form a hangable jelly-like fracturing fluid.

Herein the cross-linking agent had a composition of: 1% of formaldehyde, 0.25% of phenol, 25% of acetic acid, and the balance of water; and the cross-linking agent was prepared via the following steps:

adding an organic acid and an organic aldehyde into water, stirring and mixing them uniformly, and heating them to elevate the temperature to 94° C.; then adding an organic phenol, and allowing the reaction to proceed for 3 hours while maintaining a constant temperature, so as to produce the above non-metal-ion cross-linking agent.

The fracturing fluid was evaluated for its performance. The measurement was conducted according to the oil-and-natural gas industrial standard SY/T 5107-2005, namely “Method for evaluating the performance of a water-based fracturing fluid”, and the results are shown in Table 12.

TABLE 12
Results of evaluation of the performance of the
fracturing fluid as described herein (190° C.)

| | | | | | Viscosity of | |
|---|---|---|---|---|---|---|
| Shear | Shear viscosity (mPa · s) | | | | gel-breaking | Content of |
| Temp. | | 60.0 | 90.0 | 120.0 | fluid | residues |
| (° C.) | initial | min | min | min | (mPa · s) | (mg/L) |
| 190 | 1089.2 | 253.6 | 297.6 | 221.7 | 2.25 | 19 |

Table 12 shows that the ultra-high temperature fracturing fluid prepared in Example 12 showed characteristics such as good high-temperature resistance and shear resistance, complete gel breaking, and a low content of residues, and can satisfy the requirements of on-site operations.

### Example 13

An ultra-high temperature fracturing fluid as described herein was formulated by using 0.8% of a synthetic polymer (which was prepared by reacting acrylamide and 2-acrylamide-2-methylpropanesulfonic acid in a mass ratio of 1.7:1 at 12° C. for 4 hours, and had a viscosity average molecular weight of 6,450,000), 0.2% of a cross-linking agent, 0.2% of dodecyl ammonium chloride, 0.1% of a demulsifying agent SP169, 0.25% of ammonium persulfate, and the balance of water. The preparation process was as follows: adding 0.8% of the synthetic polymer as a thickening agent into water, followed by stirring for 1.5 hours at 400 r/min to form a uniform aqueous solution of the polymer; to the uniform aqueous solution of the polymer, sequentially adding 0.2% of dodecyl ammonium chloride, 0.1% of a demulsifying agent and 0.05% of ammonium persulfate, and mixing them uniformly before adding 0.25% of a cross-linking agent; stirring the system for 4.5 min to form a hangable jelly-like fracturing fluid.

Herein the cross-linking agent had a composition of: 1% of hexamethylene tetramine, 0.025% of hydroquinone, 0.25% of acetic acid, and the balance of water; and the cross-linking agent was prepared via the following steps:

adding an organic acid and an organic aldehyde into water, stirring and mixing them uniformly, and heating them to elevate the temperature to 94° C.; then adding an organic phenol, and allowing the reaction to proceed for 3 hours while maintaining a constant temperature, so as to produce the above non-metal-ion cross-linking agent.

The fracturing fluid was evaluated for its performance. The measurement was conducted according to the oil-and-natural gas industrial standard SY/T 5107-2005, namely “Method for evaluating the performance of a water-based fracturing fluid”, and the results are shown in Table 13.

TABLE 13
Results of evaluation of the performance of the
fracturing fluid as described herein (190° C.)

| | | | | | Viscosity of | |
|---|---|---|---|---|---|---|
| Shear | Shear viscosity (mPa · s) | | | | gel-breaking | Content of |
| Temp. | | 60.0 | 90.0 | 120.0 | fluid | residues |
| (° C.) | initial | min | min | min | (mPa · s) | (mg/L) |
| 190 | 1356.1 | 267.2 | 308.2 | 267.9 | 2.31 | 17 |

Table 13 shows that the ultra-high temperature fracturing fluid prepared in Example 13 showed characteristics such as good high-temperature resistance and shear resistance, complete gel breaking, and a low content of residues, and can satisfy the requirements of on-site operations.

### Comparative Example 1

This comparative example was carried out in the same manner as that in Example 1, except that the cross-linking agent had a composition different from that of Example 1.

Herein the cross-linking agent had a composition of: 0.7% of an organic aldehyde, 0.05% of an organic phenol, 5% of an organic alcohol, 0.5% of an organic acid, and the balance of water.

The fracturing fluid was evaluated for its performance. The measurement was conducted according to the oil-and-natural gas industrial standard SY/T 5107-2005, namely “Method for evaluating the performance of a water-based fracturing fluid”, and the results are shown in Table 14.

TABLE 14
Results of evaluation of the performance
of the fracturing fluid herein (190° C.)

| | | | | | Viscosity of | |
|---|---|---|---|---|---|---|
| Shear | Shear viscosity (mPa · s) | | | | gel-breaking | Content of |
| Temp. | | 60.0 | 90.0 | 120.0 | fluid | residues |
| (° C.) | initial | min | min | min | (mPa · s) | (mg/L) |
| 190 | 1253.2 | 125.3 | 95.3 | 56.2 | 2.21 | 26 |

### Comparative Example 2

This comparative example was carried out in the same manner as that in Example 1, except that the cross-linking agent had a composition different from that of Example 1.

Herein the cross-linking agent had a composition of: 0.5% of an organic aldehyde, 0.05% of an organic phenol, 5% of an organic alcohol, 0.7% of an organic acid, and the balance of water.

The fracturing fluid was evaluated for its performance. The measurement was conducted according to the oil-and-natural gas industrial standard SY/T 5107-2005, namely “Method for evaluating the performance of a water-based fracturing fluid”, and the results are shown in Table 15.

TABLE 15
Results of evaluation of the performance
of the fracturing fluid herein (190° C.)

| | | | | | Viscosity of | |
|---|---|---|---|---|---|---|
| Shear | Shear viscosity (mPa · s) | | | | gel-breaking | Content of |
| Temp. | | 60.0 | 90.0 | 120.0 | fluid | residues |
| (° C.) | initial | min | min | min | (mPa · s) | (mg/L) |
| 190 | 687.3 | 78.6 | 51.3 | 32.5 | 1.06 | 15 |

### Comparative Example 3

This comparative example was carried out in the same manner as that in Example 1, except that the cross-linking agent had a composition different from that of Example 1.

Herein the cross-linking agent had a composition of: 0.5% of acetaldehyde, 0.05% of an organic phenol, 5% of an organic alcohol, 0.5% of an organic acid, and the balance of water.

The fracturing fluid was evaluated for its performance. The measurement was conducted according to the oil-and-natural gas industrial standard SY/T 5107-2005, namely “Method for evaluating the performance of a water-based fracturing fluid”, and the results are shown in Table 16.

TABLE 16
Results of evaluation of the performance
of the fracturing fluid herein (190° C.)

| | | | | | Viscosity of | |
|---|---|---|---|---|---|---|
| Shear | Shear viscosity (mPa · s) | | | | gel-breaking | Content of |
| Temp. | | 60.0 | 90.0 | 120.0 | fluid | residues |
| (° C.) | initial | min | min | min | (mPa · s) | (mg/L) |
| 190 | 865.3 | 123.5 | 98.7 | 75.2 | 2.12 | 27 |

### Comparative Example 4

This comparative example was carried out in the same manner as that in Example 1, except that the cross-linking agent was used in an amount of 0.5%.

The fracturing fluid was evaluated for its performance. The measurement was conducted according to the oil-and-natural gas industrial standard SY/T 5107-2005, namely “Method for evaluating the performance of a water-based fracturing fluid”, and the results are shown in Table 17.

TABLE 17
Results of evaluation of the performance
of the fracturing fluid herein (190° C.)

| | | | | | Viscosity of | |
|---|---|---|---|---|---|---|
| Shear | Shear viscosity (mPa · s) | | | | gel-breaking | Content of |
| Temp. | | 60.0 | 90.0 | 120.0 | fluid | residues |
| (° C.) | initial | min | min | min | (mPa · s) | (mg/L) |
| 190 | 568.2 | 90.2 | 45.3 | 23.5 | 1.89 | 20 |

What is claimed is:

1. A non-metallic cross-linking agent for ultra-high temperature fracturing fluids wherein, the non-metallic cross-linking agent is prepared-from components comprising 0.1% to 0.5% of an organic aldehyde, 0.01% to 0.05% of an organic phenol, 0 to 10% of an organic alcohol, 0.05% to 0.5% of an organic acid, and the balance of water.

2. The non-metallic cross-linking agent according to claim 1, wherein the organic phenol is at least one selected from hydroquinone, resorcinol, and phenol.

3. The non-metallic cross-linking agent according to claim 1, wherein the organic aldehyde is at least one selected from paraformaldehyde, formaldehyde, and hexamethylene tetramine.

4. The non-metallic cross-linking agent according to claim 1, wherein the organic alcohol is at least one selected from n-butanol, isopropanol, and ethyl butyl propanediol.

5. The non-metallic cross-linking agent according to claim 1, wherein the organic acid is at least one selected from acetic acid, formic acid, and aminosulfonic acid.

6. A method for preparing the non-metallic cross-linking agent for ultra-high temperature fracturing fluids according to claim 1, wherein the method comprises:
adding an organic alcohol, an organic acid and an organic aldehyde into water,
heating the mixture,
adding an organic phenol, and
allowing a reaction to proceed-while maintaining a constant temperature-to produce the non-metallic cross-linking agent.

7. A fracturing fluid comprising the non-metallic cross-linking agent for ultra-high temperature fracturing fluids according to claim 1.

8. The fracturing fluid according to claim 7, further comprising a synthetic polymer synthesized from acrylamide and 2-acrylamide-2-methylpropanesulfonic acid, and has a viscosity average molecular weight between 6,000,000 to 7,000,000.

9. A method for preparing the fracturing fluid according to claim 7, the method comprising:
adding a synthetic polymer into water to form a uniform aqueous solution of the polymer;
sequentially adding dodecyl ammonium chloride, a demulsifying agent and ammonium persulfate to the uniform aqueous solution of the polymer, and
mixing followed by adding a cross-linking agent to form a hangable jelly-like fracturing fluid.

10. The fracturing fluid according to claim 7, wherein the fracturing fluid is operated at a temperature below 200° C.

11. The non-metallic cross-linking agent according to claim 1, wherein the non-metallic cross-linking agent is prepared from 0.5% of the organic aldehyde, 0.05% of the organic phenol, 5% of the organic alcohol, 0.5% of the organic acid, and the balance water.

12. The non-metallic cross-linking agent according to claim 2, wherein the organic phenol is resorcinol.

13. The non-metallic cross-linking agent according to claim 3, wherein the organic aldehyde comprises hexamethylene tetramine.

14. The non-metallic cross-linking agent according to claim 4, wherein the organic alcohol is isopropanol.

15. The non-metallic cross-linking agent according to claim 5, wherein the organic acid is aminosulfonic acid.

16. The fracturing fluid according to claim 7, comprising 0.1% to 0.25% by weight, of the non-metallic cross-linking agent.

17. The fracturing fluid according to claim 7, wherein the fracturing fluid further comprises the following components in weight percentage: 0.4% to 0.8% of a synthetic polymer, 0.1% to 0.2% of dodecyl ammonium chloride, 0.1% to 0.2% of a demulsifying agent, 0.01% to 0.3% of ammonium persulfate, and the balance water.

18. The fracturing fluid according to claim 17, wherein the fracturing fluid comprises 0.4% of the synthetic polymer, 0.2% of dodecyl ammonium chloride, 0.1% of the demulsifying agent, 0.05% of ammonium persulfate, and the balance of water.

19. The fracturing fluid according to claim 17, wherein the demulsifying agent is demulsifying agent SP169.

20. The fracturing fluid according to claim 8, wherein the synthetic polymer is obtained from acrylamide and 2-acrylamide-2-methylpropanesulfonic acid in a mass ratio of 1:1 to 3:1, and reacting at a polymerization temperature of 10° C. to 25° C.
